(19) United States
(12) Patent Application Publication
(10) Pub. No.: US 2022/0335393 A1
(43) Pub. Date: Oct. 20, 2022

(54) SMARTGLASSES BASED CHEQUE FAULT DISCERN AND ABATEMENT ENGINE

(71) Applicant: Bank of America Corporation, Charlotte, NC (US)

(72) Inventors: Saurabh Gupta, New Delhi (IN); Suman Boroi Tamuly, Assam (IN); Ankit Upadhyaya, Gurugram (IN); Prashant Anna Bidkar, Delhi (IN)

(21) Appl. No.: 17/233,782

(22) Filed: Apr. 19, 2021

(51) Int. Cl. G06Q 20/04; G06Q 20/32; G06Q 20/10; G02B 27/01

(52) U.S. Cl. CPC G06Q 20/0425; G06Q 20/321; G06Q 20/108; G02B 27/0172; G02B 2027/0178

(57) ABSTRACT

A method for A method for utilizing a check-to-smartglasses payment system is provided. The method may include capturing check data at a smartglasses. The method may also include identifying smartglasses account data associated with the smartglasses. In addition, the method may include generating a transfer of funds instruction. The transfer of funds instruction may include the check data and the smartglasses account data. The method may also include transmitting the transfer of funds instruction to a financial institution as well as identifying an account associated with the check data at the financial institution, The method may also include processing the transfer of funds instruction between the account associated with the check data and an account identified by the smartglasses account data at the financial institution and transmitting a confirmation to the smartglasses and to a mobile device associated with the check data.

### FIELD OF TECHNOLOGY

Aspects of the disclosure relate to document analysis and verification. More particularly, this disclosure relates to systems and processes for scanning, reviewing and authenticating paper checks.

### BACKGROUND OF THE DISCLOSURE

Major financial institutions are unable to process thousands of checks every month because of various reasons like the reasons set forth below.

STP (Straight Through Processing) rejects attributable to Low confidence level;

Check Image Not Clear-Poor scanning quality;

Overwritten/Altered Checks;

Handwritten checks;

Folded/Cut checks;

Piggyback checks (Two checks uploaded in one pass);

Magnetic Ink Character Recognition (MICR) line and/or amount missing on check; and/or

Account Restrictions/Third Party Restrictions associated with processing of check.

Currently, there is no centralized platform independent solution available for all problems related to paper checks.

Therefore, it would be desirable to provide a centralized platform that is configured to solve for a plurality of known problems related to paper checks.

Several solutions can cater to the first and/or second problem enumerated above.

However, these known solutions are typically platform-dependent and not universally, and platform-agnostically, available.

It would also be desirable to provide a platform-independent solution to solve for the problems identified above.

### SUMMARY OF THE DISCLOSURE

A method for utilizing a check-to-smartglasses system is provided. The method may include capturing check data at a smartglasses. The method may also include identifying smartglasses data associated with the smartglasses. Such data may include a mobile phone number associated with the smartglasses, or other identifying information.

Additionally, the method may include generating check transaction instructions. The check transaction instructions may include check data and the smartglasses identification data and transmitting the check transaction instructions to an entity. The method may further include identifying information associated with the check data at the entity, processing the transaction instructions between an account associated with the check data and an account identified by the smartglasses data at the entity, and transmitting a confirmation to the smartglasses and to a mobile device associated with the check data.

### BRIEF DESCRIPTION OF THE DRAWINGS

The objects and advantages of the invention will be apparent upon consideration of the following detailed description, taken in conjunction with the accompanying drawings, in which like reference characters refer to like parts throughout, and in which:

FIG. 1 shows an illustrative block diagram of system for in accordance with principles of the disclosure;

FIG. 2 shows illustrative apparatus that may be configured in accordance with the principles of the disclosure.

FIG. 3 shows an illustrative schematic diagram of a system according to the disclosure;

FIG. 4 shows another illustrative schematic diagram of a system according to the disclosure; and

FIG. 5 shows an illustrative flow diagram according to the principles of the disclosure.

### DETAILED DESCRIPTION OF THE DISCLOSURE

Systems and methods according to the invention preferably create a smartglasses-based check fault discern and abatement engine. This engine is preferably a turn-key solution for all readily known problems related to check verification and crediting.

This technology preferably enables the smartglasses to quickly and efficiently identify any problems associated with the check. Specifically, this technology preferably reduces, if not eliminates, manual errors on the check, removes and/or resolves unclear portions of the check, predicts handwriting for unclear portions, generates a final e-check and submits automatically to the financial institution (FI) by, in certain embodiments, hovering the smartglasses over the check.

The embodiments may further involve live—i.e., real time—bank integration. For example, this technology preferably establishes automatic connection with the sender's and the receiver's bank using, for example, a mobile number of a receiver and the check document of sender, in order to verify the check information directly. Once verified, the smartglasses may be used to submit the check to the receiver's bank.

Furthermore, this technology leverages legacy samples of handwriting of the sender. The technology retrieves, for example, handwriting from prior documents and suggests inputs, where unclear or omitted, for the check as well.

In addition, this technology determines whether the check sender has enough balance or not in his account to satisfy the amount of the check or not.

Also, this technology may inquire and stop a check drawn on a questionable account—as well as examine if the sender's account if questionable or not.

Further, this technology may utilize an e-check assist program which can automatically generate e-checks. In addition, the disclosed technology may be used in order to remove overwritten and/or unclear portions of the hand-written checks. In some embodiments, this technology can auto submit checks to receiver's FI for payment.

Illustrative method steps may be combined. For example, an illustrative method may include steps shown in connection with another illustrative method.

Apparatus may omit features shown or described in connection with illustrative apparatus. Embodiments may include features that are neither shown nor described in connection with the illustrative apparatus. Features of illustrative apparatus may be combined. For example, an illustrative embodiment may include features shown in connection with another illustrative embodiment.

Apparatus and methods described herein are illustrative. Apparatus and methods in accordance with this disclosure will now be described in connection with the figures, which form a part hereof. The figures show illustrative features of apparatus and method steps in accordance with the principles of this disclosure. It is understood that other embodiments may be utilized, and that structural, functional, and procedural modifications may be made without departing from the scope and spirit of the present disclosure.

Generally, the instant application relates to smartglasses. Such smartglasses may include still cameras or video cameras. Such still cameras may take photographs that include 8-megapixel or more or less than 8-megapixels.

Video cameras for use in or with smartglasses may take videos at 60 frames per second, or more or less than 60 frames per second. Such video cameras may, in certain embodiments, include 3D cameras or 2D cameras.

Such smartglasses may be equipped with speakers. Such speakers may include directional speakers, bone conduction audio technology, open-ear audio or speakers and/or any other suitable speaker systems.

Such smartglasses may be equipped with one or more microphones.

Such smartglasses may be equipped with a display. The display may include a 640 pixel x 360 pixel RGB display or other suitable display containing more or less or the same number of pixels. Such merged brain activity can be used together with the other features set forth herein to help the receiver process the check.

Such smartglasses may be equipped with one or more devices for measuring brain activity.

Such smartglasses may be equipped with devices for measuring and/or tracking steps, calories or distance travelled.

Architecture for a smartglasses device is provided.

Smartglasses may be understood to mean wearable glasses that include both hardware and software components. One or more processors may be included in the hardware components of the smartglasses. The one or more processors may include one or more microprocessors. The microprocessor may provide processing capabilities to the plurality of hardware components and the plurality of software components within the smartglasses.

In addition to the processors, smartglasses may also include hardware components associated with conventional glasses. Such conventional components may include a frame and lenses.

Other hardware components of smartglasses may include one or more displays, one or more cameras for capturing photographs and/or videos, one or more audio input devices, one or more audio output devices, one or more communication transceivers, one or more wired and/or wireless communication applications (e.g., Bluetooth ®, Beacon ®) and/or any other suitable hardware components.

The smartglasses display may display data as instructed by the microprocessor. In one embodiment, the smartglasses display may be physically configured to add data alongside what the wearer sees through the lenses. In some embodiments, the smartglasses display may display data as an at least partially transparent overlay on top the lenses. As such, the user may view, through the overlay, the physical objects that are normally seen through lenses. Such a smartglasses display may be known as an augmented reality smartglasses display.

Additionally, smartglasses may utilize cellular technology or Wi-Fi to be enable to be operable as wearable computers which may run self-contained mobile applications. Smartglasses may be hands-on and/or handsfree and may be enabled to communicate with the Internet through natural language voice commands. Some smartglasses may require the use of touch buttons on the frame.

The weight of such smartglasses devices may be in the area of between about 20 grams to 60 grams or less or more than this range.

The width of the lenses of such smartglasses devices may be between about 45 millimeters (mm) and 65 mm, and most preferably between about 50 mm to 56 mm. The length of the frames may be between about 126 mm and 153 mm.

Another component of smartglasses may include the ability for smartglasses to modify its optical properties, such as tint and prescription of the lenses. The optical properties modification may be executed at any given time. Smartglasses may change optical properties of the lenses by executing one or more software applications on the internal processors.

Smartglasses may also include one or more communication transceivers. The communication transceivers may be operable to communicate with external processors. The external processors may be included in a mobile device or any other suitable computing device.

The smartglasses may include a scanning device. The scanning device may be a camera. The scanning device may be configured to scan application source code displayed on a user interface (“UI”).

The UI may be a screen. The screen may be connected to a computer, laptop, iPad™ and/or any other electronic device. In some embodiments, the UI may be a non-electronic device.

Finally, this technology preferably performs most or all the above-described functions in a time period that is less than onerous for the action desired—i.e., cheque fault discernment and abatement. Such a time period should be, in total, less than 3-5 seconds total, preferably less than 2 seconds, and most preferably less than 1 second.

A smartglasses check fault discern and abatement device is provided.

The smartglasses may include a battery. The battery may be configured to power the microprocessor, the scanning device and the display.

The smartglasses may include a nano wireless network interface card (“NIC”). The nano wireless NIC may be a circuit board and/or a chip, installed within the smartglasses, that enables the smartglasses to establish communication with a wireless network. The nano wireless NIC may support input/output (“'I/O”), interrupt, direct memory access, interfaces, data transmission, network traffic engineering and/or partitioning.

The nano wireless NIC may provide the smartglasses with a dedicated, full-time connection to a wireless network. The nano wireless NIC may provide the connection by implementing the physical layer circuitry necessary for communicating with a data link layer standard, such as Wi-Fi.

The nano wireless NIC may operate as an intermediary between the smartglasses and a wireless network. For example, the processor may transmit a request to the nano wireless NIC. The nano wireless NIC may convert the request into electrical impulses. The electrical impulses may be transmitted to a web server. The web server may respond to the nano wireless NIC with additional electrical signals. The nano wireless NIC receives the additional electrical signals. The nano wireless NIC translates the additional electrical signals into data that is consumable by the microprocessor.

The smartglasses may also include an active near field communication (“NFC”) reader configured to establish a communication with one or more other smartglasses devices within a pre-determined proximity to the smartglasses device. Smartglasses may communicate with one or more additional smartglasses and other smart devices using NFC technology.

The smartglasses may include software components. One or more software modules may execute on the processors. The one or more software applications may be stored in a memory located within the smartglasses. The one or more software modules may, in the alternative, be referred to as applications. The applications may enable the smartglasses to execute various tasks.

The smartglasses device may include a contactless communication application. The contactless communication application may operate on the smartglasses processor. The contactless communication application may initiate communication with another smartglasses. In some embodiments, the contactless communication application may be an active near field communication (“NFC”) reader. As such, the contactless communication application may communicate with another smartglasses using NFC technology.

The device may also include a handwriting assist engine for leveraging, based on handwriting analysis, a plurality of legacy check documents to determine a level of authority associated with the current check. The device may include a balance and suspicious account information engine for helping to determine the level of authority based on balance and suspicious account information associated with an account number and a routing code of the current check.

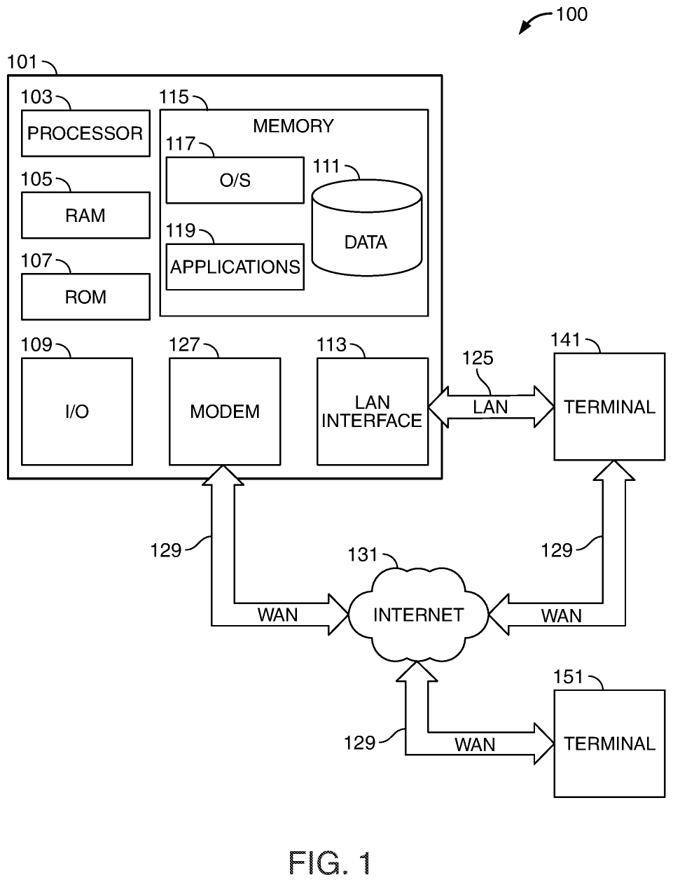

FIG. 1 shows an illustrative block diagram of system 100 that includes computer 101. Computer 101 may alternatively be referred to herein as a “server” or a “computing device.” Computer 101 may be a workstation, desktop, laptop, tablet, smart phone, or any other suitable computing device. Elements of system 100, including computer 101, may be used to implement various aspects of the systems and methods disclosed herein.

Computer 101 may have a processor 103 for controlling the operation of the device and its associated components, and may include RAM 105, ROM 107, input/output module 109, and a memory 115. The processor 103 may also execute all software running on the computer—e.g., the operating system and/or voice recognition software. Other components commonly used for computers, such as EEPROM or Flash memory or any other suitable components, may also be part of the computer 101.

The memory 115 may be comprised of any suitable permanent storage technology—e.g., a hard drive. The memory 115 may store software including the operating system 117 and application(s) 119 along with any data 111 needed for the operation of the system 100. Memory 115 may also store videos, text, and/or audio assistance files. The videos, text, and/or audio assistance files may also be stored in cache memory, or any other suitable memory. Alternatively, some or all of computer executable instructions (alternatively referred to as “code”) may be embodied in hardware or firmware (not shown). The computer 101 may execute the instructions embodied by the software to perform various functions.

Input/output (“I/O”) module may include connectivity to a microphone, keyboard, touch screen, mouse, and/or stylus through which a user of computer 101 may provide input. The input may include input relating to cursor movement. The input may relate to cash verification and remote deposit. The input/output module may also include one or more speakers for providing audio output and a video display device for providing textual, audio, audiovisual, and/or graphical output. The input and output may be related to computer application functionality.

System 100 may be connected to other systems via a local area network (LAN) interface 113.

System 100 may operate in a networked environment supporting connections to one or more remote computers, such as terminals 141 and 151. Terminals 141 and 151 may be personal computers or servers that include many or all of the elements described above relative to system 100. The network connections depicted in FIG. 1 include a local area network (LAN) 125 and a wide area network (WAN) 129, but may also include other networks. When used in a LAN networking environment, computer 101 is connected to LAN 125 through a LAN interface or adapter 113. When used in a WAN networking environment, computer 101 may include a modem 127 or other means for establishing communications over WAN 129, such as Internet 131.

It will be appreciated that the network connections shown are illustrative and other means of establishing a communications link between computers may be used. The existence of various well-known protocols such as TCP/IP, Ethernet, FTP, HTTP and the like is presumed, and the system can be operated in a client-server configuration to permit a user to retrieve web pages from a web-based server. The web-based server may transmit data to any other suitable computer system. The web-based server may also send computer-readable instructions, together with the data, to any suitable computer system. The computer-readable instructions may be to store the data in cache memory, the hard drive, secondary memory, or any other suitable memory.

Additionally, application program(s) 119, which may be used by computer 101, may include computer executable instructions for invoking user functionality related to communication, such as e-mail, Short Message Service (SMS), and voice input and speech recognition applications. Application program(s) 119 (which may be alternatively referred to herein as “plugins,” “applications,” or “apps”) may include computer executable instructions for invoking user functionality related performing various tasks. The various tasks may be related to monitoring electronic teleconferences.

Computer 101 and/or terminals 141 and 151 may also be devices including various other components, such as a battery, speaker, and/or antennas (not shown).

Terminal 151 and/or terminal 111 may be portable devices such as a laptop, cell phone, Blackberry™, tablet, smartphone, or any other suitable device for receiving, storing, transmitting and/or displaying relevant information. Terminals 151 and/or terminal 111 may be other devices. These devices may be identical to system 100 or different. The differences may be related to hardware components and/or software components.

Any information described above in connection with database 111, and any other suitable information, may be stored in memory 115. One or more of applications 119 may include one or more algorithms that may be used to implement features of the disclosure, and/or any other suitable tasks.

The invention may be operational with numerous other general purpose or special purpose computing system environments or configurations. Examples of well-known computing systems, environments, and/or configurations that may be suitable for use with the invention include, but are not limited to, personal computers, server computers, hand-held or laptop devices, tablets, mobile phones, smart phones and/or other personal digital assistants (“PDAs”), multiprocessor systems, microprocessor-based systems, set top boxes, programmable consumer electronics, network PCs, minicomputers, mainframe computers, distributed computing environments that include any of the above systems or devices, and the like.

The invention may be described in the general context of computer-executable instructions, such as program modules, being executed by a computer. Generally, program modules include routines, programs, objects, components, data structures, etc., that perform particular tasks or implement particular abstract data types. The invention may also be practiced in distributed computing environments where tasks are performed by remote processing devices that are linked through a communications network. In a distributed computing environment, program modules may be located in both local and remote computer storage media including memory storage devices. It should be noted that such module may be considered, for the purposes of this application, as engines with respect to the performance of the particular tasks to which the modules are assigned.

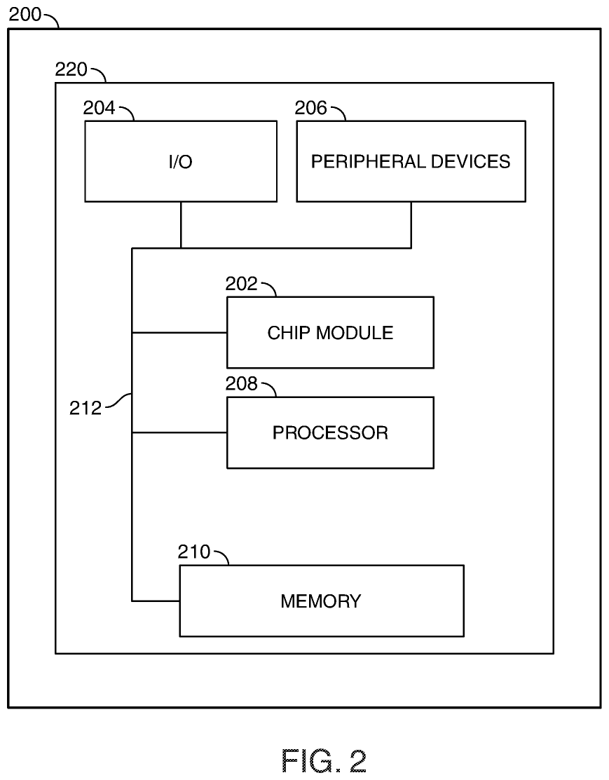

FIG. 2 shows illustrative apparatus 200 that may be configured in accordance with the principles of the disclosure. Apparatus 200 may be a computing machine. Apparatus 200 may include one or more features of the apparatus shown in FIG. 1. Apparatus 200 may include chip module 202, which may include one or more integrated circuits, and which may include logic configured to perform any other suitable logical operations.

Apparatus 200 may include one or more of the following components: I/O circuitry 204, which may include a transmitter device and a receiver device and may interface with fiber optic cable, coaxial cable, telephone lines, wireless devices, PHY layer hardware, a keypad/display control device or any other suitable media or devices; peripheral devices 206, which may include counter timers, real-time timers, power-on reset generators or any other suitable peripheral devices; logical processing device 208, which may compute data structural information and structural parameters of the data; and machine-readable memory 210.

Machine-readable memory 210 may be configured to store in machine-readable data structures: machine executable instructions (which may be alternatively referred to herein as “computer instructions” or “computer code”), applications, signals, and/or any other suitable information or data structures.

Components 202, 204, 206, 208 and 210 may be coupled together by a system bus or other interconnections 212 and may be present on one or more circuit boards such as 220. In some embodiments, the components may be integrated into a single chip. The chip may be silicon-based.

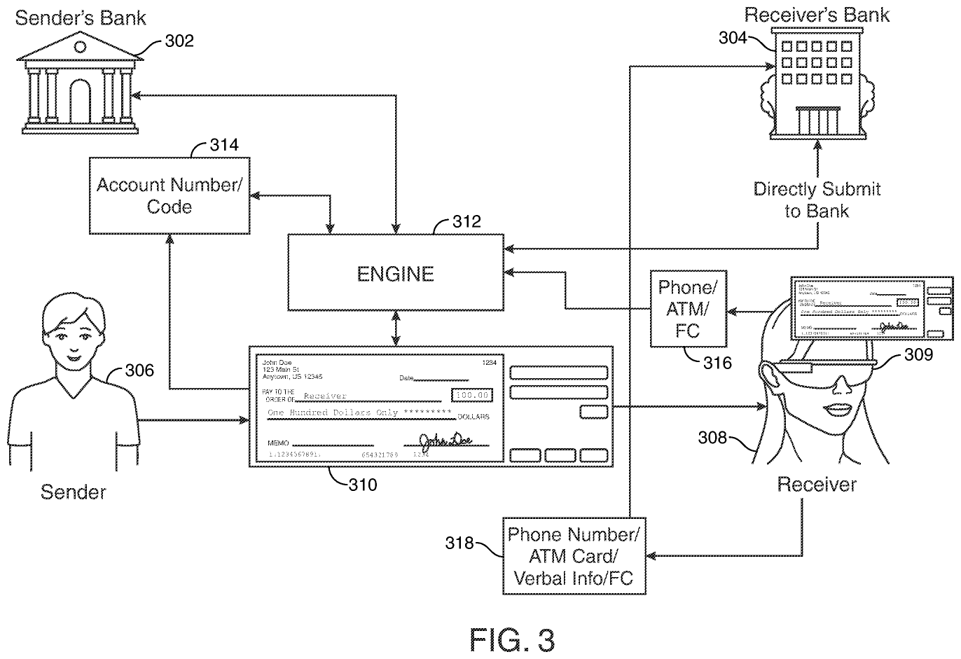

FIG. 3 shows an illustrative schematic diagram of a system according to the disclosure. The process shown in FIG. 3 may involve the transfer of a paper check leaf 310 (hereinafter a “check”) from a sender 306 to a receiver 308.

The engine 312 for check discernment and abatement may be coupled both to the sender's bank 302 and/or the receiver's bank 304. Engine 312 may preferably initiate the process by sending the check account number and/or the bank code, such as a routing number, to engine 312, as shown at 314.

The check may be physically delivered to receiver 308 by sender 306. Receiver 308 may then typically be imaged by a camera located in smartglasses 309 and then transferred (shown at 316) via an electronic hook-up using a phone connection, via an ATM or at a financial center (FC) (or other suitable medium of communication) to engine 312. It should be noted that smartglasses account information for any transaction may, in certain embodiments, preferably be derived using a mobile number-to-bank resolver whereby the resolver determines the relevant bank account associated with the smartglasses by leveraging the mobile number associated with the smartglasses.

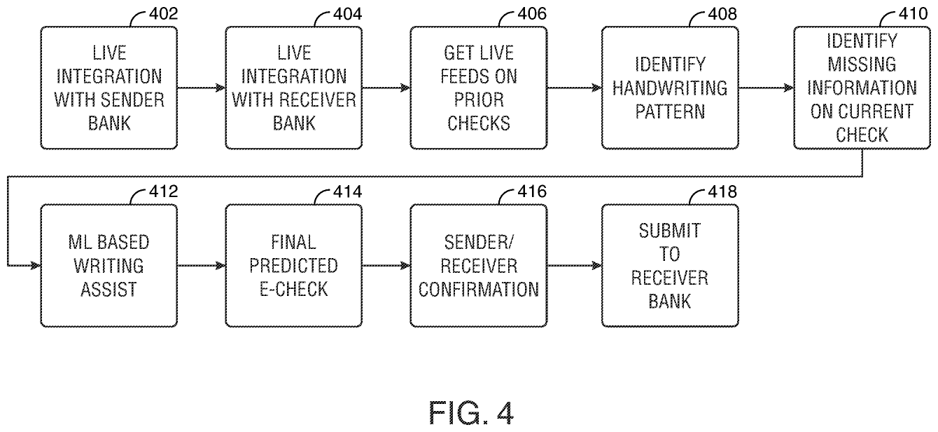

Upon receipt of the image of the check 310 by engine 312, engine 312 may be configured to perform one or more of the steps set forth in FIG. 4, and described therein, in detail below.

While the receiver may transfer the check 310 to receiver's bank 304 via engine 312, it should be noted that check 310 may alternatively, or simultaneously, be transferred to receiver's bank 304 using information transferred via a dial-in phone number, information uploaded to an ATM machine, verbal information reported to a financial center or through any other suitable medium of transfer, as shown at 318.

FIG. 4 shows another illustrative schematic diagram of a system according to the disclosure. At step 402, live integration with the sender bank is shown. Step 404 shows live integration with the receiver bank.

Step 406 shows receiving live—i.e., substantially real-time—feeds on prior checks. These live feeds preferably enable the system to make on-the-fly comparisons with legacy checks. Such comparisons may preferably leverage information stored in memory to help determine the veracity and accuracy of checks under review.

At 408, FIG. 4 shows identifying handwriting patterns. Such patterns may be useful in determining the veracity of signatures, or amounts, on checks.

Step 410 shows identifying missing information on a current check. At step 412, machine learning (ML) is used for writing assist. Such a step may preferably use, for example, legacy writing patterns and error patterns to aid in determining the most correct assumption for the current check under review.

In one such exemplary use of ML algorithms, a pre-determined user may commonly write a “4” that appears to be a “2” in the number field of a check such as check 310. However, the written description of the check may contradict the number portion of the check. As such, the check may be determined to be an exception—which requires additional resources to resolve. However, if the ML library has stored knowledge relating to the pre-determined user's practice of writing a “4” that appears to be a “2” then the ML can be leveraged to clarify the check amount prior to characterizing the check as an exception. It should be noted that, while the foregoing example relates to ML in the area of personal handwriting, ML, according to the disclosure may be leveraged with respect to any information relevant to the check processing for which legacy information is available.

At 414, the system may preferably produce a final, predicted, e-check for confirmation or review by the sender and/or the receiver, as shown at step 416. The e-check may then be sent to receiver bank, as shown at 418, for a traditional clearing.

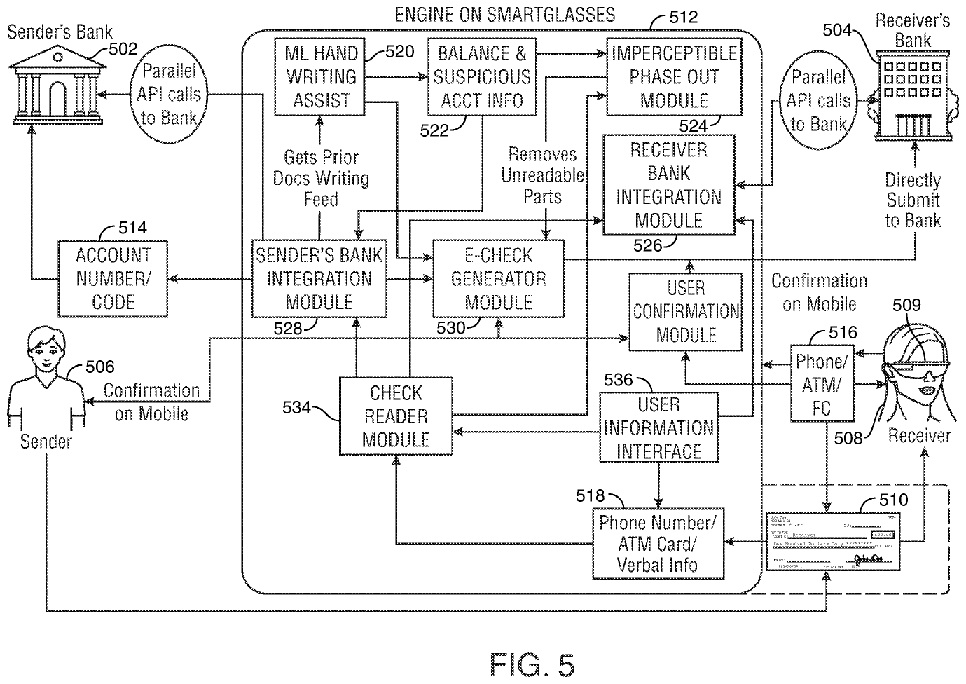

FIG. 5 shows an illustrative flow diagram according to the principles of the disclosure. With respect to elements 502, 504, 506, 508, 509, 510, 514, 516 and 518, FIG. 5 is the same as FIG. 4. It should be noted, however, that additional detail is indicated with respect to the communications to sender 502 and receiver 508. Specifically, it is indicated in FIG. 5 that such additional detail may include sending confirmation of the check transaction to the mobile channel associated with the sender and/or the receiver.

With respect to engine 512 on smartglasses, FIG. 5 shows a detailed version of components preferably housed within smartglasses according to the disclosure. Such components include the following exemplary components:

Illustrative Components in Engine 512
ML Handwriting Assist 520
Balance & Suspicious Account Information Module 522
Imperceptible Phase Out Module 524
Receiver Bank Integration Module 526
Sender's Bank Integration Module 528
E-Check Generator Module 530
User Confirmation Module 532
Check Reader Module 534
User Information Interface 536
Other suitable illustrative concurrent steps

The operation and characterization of ML handwriting assist 520 maps on the ML based writing assist 412 described above.

The balance & suspicious account information module 522 may be used to determine whether there are balance issues and/or proprietorship issues with the account and/or code associated with the check.

Imperceptible phase out module 524 may be used to remove any unreadable parts of the check prior to generating the e-check using the e-check generator module 530.

Receiver Bank Integration Module 526 may be used to enable communication to receiver's bank 504. It should be noted that, in certain embodiments, these communications may be performed via parallel API calls to receiver's bank 504. Such parallel API calls may preferably be performed in parallel to direct communication.

Sender's Bank Integration Module 528 may perform a similar function as Receiver Bank Integration Module 526 but with regards to the sender's bank instead of the receiver's bank. It should be noted that, in certain embodiments, these communications may be performed via parallel API calls to sender's bank 504. Such parallel API calls may preferably be performed in parallel to direct communication, as shown at 514.

E-check generator module 530 maps on the functions described above with respect to generation of an e-check.

User confirmation module is shown at 532 and involves receiving, via phone, ATM, financial center or other channel, a user confirmation of the generated check.

Check reader module 534 may receive check information from user information interface 536. Such information may include the check itself 510. Check 510 may be uploaded using a phone number an ATM card or verbal information to check reader module 534.

It should be noted that, for the purposes of this application, when verbal information is denoted with regards to checks the verbal information may also contain inconsistencies and/or omissions. Such inconsistencies and/or omissions may be mitigated using the systems and methods described herein for the purposes of mitigating inconsistencies and/or omissions with regards to paper checks.

Thus, systems and methods directed to a smartglasses-based check fault discern and abatement engines are provided. Persons skilled in the art will appreciate that the present invention can be practiced by other than the described embodiments, which are presented for purposes of illustration rather than of limitation. The present invention is limited only by the claims that follow.

What is claimed is:

1. A method for utilizing a check-to-smartglasses system, the method comprising:
capturing check data at a smartglasses;
identifying smartglasses data associated with the smartglasses;
generating check transaction instructions, the check transaction instructions comprising:
the check data; and
the smartglasses data;
transmitting the check transaction instructions to an entity;
identifying information associated with the check data at the entity;
processing the transaction instructions between an account associated with the check data and an account identified by the smartglasses data at the entity; and
transmitting a confirmation to the smartglasses and to a mobile device associated with the check data.

2. The method of claim 1 wherein the smartglasses comprises a length of between about 120 millimeters (mm) and 160 mm.

3. The method of claim 1 wherein the smartglasses comprises a lens width of between about 45 millimeters (mm) and 65 mm.

4. A smartglasses check fault discern and abatement device, said device for confirming a current check, the device comprising a weight between 20 grams to 60 grams, the device comprising:
a handwriting assist engine for leveraging, based on handwriting analysis, a plurality of legacy check documents to determine a level of authority associated with the current check; and
a balance and suspicious account information engine for helping to determine the level of authority based on balance and suspicious account information associated with an account number and a routing code of the current check.

5. The smartglasses check fault discern and abatement device of claim 4 further comprising an imperceptible phase out engine, said imperceptible phase out engine for removing an unreadable part of the current check.

6. The smartglasses check fault discern and abatement device of claim 4 further comprising an integration engine for integrating operation of the smartglasses check fault discern and abatement device with one or more financial institutions.

7. The smartglasses check fault discern and abatement device of claim 4 further comprising an e-check generator engine, said e-check generator engine comprising a user confirmation engine.

8. The smartglasses check fault discern and abatement device of claim 4 further comprising a check reader engine.

9. The smartglasses check fault discern and abatement device of claim 4 further comprising a user information interface.

10. The smartglasses check fault discern and abatement device of claim 4 further comprising a length of between about 120 millimeters (mm) and 160 millimeters (mm).

11. The smartglasses check fault discern and abatement device of claim 4 further comprising a lens width of between about 45 millimeters (mm) and 65 millimeters (mm).

12. A method for utilizing a check-to-smartglasses payment system, the method comprising:
capturing check data at a smartglasses;
identifying smartglasses account data associated with the smartglasses;
generating a transfer of funds instruction, the transfer of funds instruction comprising:
the check data; and
the smartglasses account data;
transmitting the transfer of funds instruction to a financial institution;
identifying an account associated with the check data at the financial institution;
processing the transfer of funds instruction between the account associated with the check data and an account identified by the smartglasses account data at the financial institution; and
transmitting a confirmation to the smartglasses and to a mobile device associated with the check data.

13. The method of claim 12 further comprising removing an unreadable part of the current check.

14. The method of claim 12 further comprising integrating an operation of the smartglasses with one or more financial institutions.

15. The method of claim 12 further comprising using an e-check generator engine to generate an e-check based on the check data, and prompting a user to confirm said e-check using a user confirmation engine.

16. The method of claim 12 further comprising providing a user information interface to receiver user input associated with the check data.

17. The method of claim 12 wherein the smartglasses comprises a length of between about 120 millimeters (mm) and 160 mm.

18. The method of claim 12 wherein the smartglasses comprises a lens width of between about 45 millimeters (mm) and 65 mm.
